(19) United States
(12) Patent Application Publication
(10) Pub. No.: US 2024/0254007 A1
(43) Pub. Date: Aug. 1, 2024

(54) FILTRATION SYSTEM

(71) Applicant: HifilM INC., Yongin-si (KR)

(72) Inventors: Hee-Wan MOON, Yongin-si (KR); Yong-Cheol Shin, Yongin-si (KR); Ho-Chan Jung, Yongin-si (KR)

(73) Assignee: HifilM INC., Yongin-si (KR)

(21) Appl. No.: 18/409,394

(22) Filed: Jan. 10, 2024

(30) Foreign Application Priority Data
Jan. 30, 2023 (KR) 10-2023-0011568

(51) Int. Cl. C02F 1/00

(52) U.S. Cl. CPC C02F 1/001; C02F 2201/008; C02F 2303/20

(57) ABSTRACT

Disclosed is a filtration system capable of (i) reciprocating a filtration apparatus in feed water to be treated such that membrane fouling can be inhibited during water treatment at a relatively small amount of energy, and (ii) preventing damage to parts, thereby dramatically reducing operation and maintenance costs. The filtration system includes a filtration tank into which feed water to be treated is introduced, at least one filtration apparatus configured to perform filtration while at least a part thereof is submerged in the feed water, a driving unit for reciprocating motion of the filtration apparatus, a first rail configured to reciprocate together with the filtration apparatus, a second rail configured to guide the reciprocating motion of the filtration apparatus, and a free-roller located between the first and second rails, the free-roller being movable relative to both the first and second rails.

### CROSS REFERENCE TO RELATED APPLICATIONS

This application claims priority based on Korean Patent Application No. 10-2023-0011568 filed on Jan. 30, 2023 in the Korea Intellectual Property Office, of which the entire content is incorporated by reference herein.

### BACKGROUND

### Technical Field

The present disclosure relates to a filtration system, and more particularly to a submerged-type filtration system capable of reciprocating a filtration apparatus in feed water to be treated, whereby it is possible not only to inhibit the occurrence of membrane fouling during water treatment at a relatively small amount of energy but also to prevent damage to parts, thereby dramatically reducing operation and maintenance costs.

### Description of the Related Art

Separation methods for water treatment, i.e., methods for purifying a water by separating contaminants therefrom, include a method using a filtration membrane, a method using heat or phase-change, and so on.

The separation method using a filtration membrane has a lot of advantages over the method using heat or phase-change. Among the advantages is the high reliability of water treatment since the water of desired purity can be easily and stably obtained by adjusting the size of the pores of the filtering membrane. Furthermore, since the separation method using a filtering membrane does not require a heating process, the method can be used together with microorganisms which are useful for separation process but might be adversely affected by heat.

The filtration membrane may be classified into a flat sheet membrane and a hollow fiber membrane, depending on its shape.

As the water treatment using the filtration membrane is performed, membrane fouling due to contaminants (i.e. membrane contamination) occurs, whereby permeability of the filtration membrane is greatly reduced. Since various kinds of filtration membrane contaminants cause membrane contamination in different manners, it is also required to clean the filtration membrane with various cleaning methods. For example, cleaning of a contaminated filtration membrane may be classified into a continuous cleaning, a maintenance cleaning, and a recovery cleaning, depending on the purpose thereof.

The recovery cleaning, which is a cleaning performed using chemicals for a relatively long time after interruption of the filtration operation, is carried out when the permeability of the filtration membrane is seriously reduced due to the accumulated contamination of the membrane after water treatment operation for a long time. The recovery cleaning substantially restores the permeability of the filtration membrane to the original degree thereof.

On the other hand, the maintenance cleaning is a cleaning performed while water treatment using a filtration membrane is performed or water treatment operation is paused for a moment. The main purpose of the maintenance cleaning is to maintain the permeability of the filtration membrane in a good state. Such maintenance cleaning is performed using a chemical method and a physical method.

The continuous cleaning is performed generally using an aeration method which ejects air supplied from a blower to the filtration membrane through aeration holes of an aeration tube while water treatment is performed, thereby removing contaminants from a surface of the membrane. In the aeration method, the contaminants are removed from the surface of the membrane as the rising air bubbles collide with the impurities and cause the turbulence of feed water.

However, the continuous aeration requires huge amount of energy consumption by the blower. Although a cyclic aeration was proposed as a method of reducing energy consumption, there was a limit in reducing the energy consumption since a cleaning purpose of preventing deterioration of filtration efficiency due to the filtration membrane contamination must be achieved.

In order to overcome the problem of aeration cleaning, Korean Patent Application Publication No. 10-2018-0062257A (hereinafter referred to as “Prior Art 1”) proposes an apparatus and method capable of preventing or reducing membrane contamination through reciprocating motion of a filtration membrane in feed water to be treated. Specifically, Prior Art 1 discloses that a plurality of filtration apparatuses are coupled to a single reciprocating frame having a plurality of rollers mounted thereon, and the reciprocating frame is reciprocated along a guide rail by means of a driving unit during the water treatment, whereby the filtration membranes installed in each of the filtration apparatuses are cleaned.

The method of Prior Art 1 has an advantage in that the energy consumption amount is smaller than that of the aeration cleaning method. However, it has a problem in that all the rollers of the reciprocating frame cannot simultaneously get in contact with the guide rail due to the flatness difference between the reciprocating frame and the guide rail, which causes load bias toward some rollers in contact with the guide rail and accelerates the wear of the rollers and the breakage of the bearings. In addition, contact and non-contact of the rollers with the guide rail during the reciprocating movement of the reciprocating frame repeatedly occur, which causes considerable noise as well as damage to the rollers due to the contact impact.

### SUMMARY

Therefore, the present disclosure relates to a filtration system capable of preventing problems resulting from limitations and shortcomings of the related art described above.

It is an object of the present disclosure to provide a filtration system capable of (i) cleaning a filtration membrane just with an amount of energy less than required in an aeration cleaning method, (ii) preventing damage to parts, thereby dramatically reducing operation and maintenance costs, and (iii) inhibiting noise.

In addition to the above object, other features and advantages of the present disclosure will be described hereinafter, or will be clearly understood by those skilled in the art to which the present disclosure pertains from the following description thereof.

In accordance with an aspect of the present disclosure, the above and other objects can be accomplished by the provision of a filtration system including a filtration tank into which feed water to be treated is introduced, at least one filtration apparatus configured to perform filtration in the state in which at least a part of the filtration apparatus is submerged in the feed water, a driving unit for reciprocating motion of the filtration apparatus, a first rail configured to reciprocate together with the filtration apparatus, a second rail configured to guide the reciprocating motion of the filtration apparatus, and a free-roller located between the first and second rails, the free-roller being movable relative to both the first and second rails.

The filtration system may include a plurality of the filtration apparatuses, the filtration system may further include a reciprocating frame to which the filtration apparatuses are individually coupled, the driving unit may be configured to implement the reciprocating motion of the filtration apparatuses through the reciprocating frame, the reciprocating frame may have a bottom surface that faces the free-roller, and the first rail may be mounted on the bottom surface of the reciprocating frame.

The first rail may be elastically mounted on the bottom surface of the reciprocating frame such that the distance between the first rail and the reciprocating frame is variable.

The reciprocating frame may have a through-hole extending from a top surface thereof, which is opposite the bottom surface, to the bottom surface, the first rail may be mounted on the bottom surface of the reciprocating frame by means of a coupling member, the coupling member may include a head located over the top surface of the reciprocating frame, a screw end inserted into the first rail, and a central body between the head and the screw end, the central body being movable along the through-hole and having a length longer than the through-hole, and an elastic member may be interposed between the reciprocating frame and the first rail.

The central body may include an exposed portion between the bottom surface of the reciprocating frame and the first rail, and the elastic member may be a spring surrounding the exposed portion.

The filtration system may further include a guide frame provided on the filtration tank, the guide frame may have a top surface that faces the free-roller, and the second rail may be mounted on the top surface of the guide frame.

The filtration system may further include a pivot member having a central hole, a first end of the pivot member may be pivotably coupled to the guide frame, a second end of the pivot member may be a two-pronged end having first and second fingers, a rotating shaft connected to a rotation axis of the free-roller may extend through the central hole of the pivot member, and a protrusion provided at the reciprocating frame may be disposed in a gap between the first and second fingers.

The protrusion may be a circular ring member coupled to the reciprocating frame by means of a screw.

The filtration system may further include a separation-preventing member coupled to an end of the rotating shaft such that the central hole is between the free-roller and the separation-preventing member.

The filtration system may include a plurality of the filtration apparatuses, each of the filtration apparatuses may include a skid frame and a plurality of membrane modules installed in the skid frame, the skid frame may include a supporting frame, a lower horizontal frame, an upper horizontal frame located between the supporting frame and the lower horizontal frame, and a plurality of vertical members configured to connect the supporting frame, the upper horizontal frame, and the lower horizontal frame to each other, the supporting frame may have a bottom surface that faces the free-roller, and the first rail may be mounted on the bottom surface of the supporting frame.

Each of the membrane modules may include an upper header having a first outlet port at one end thereof, a lower header having a second outlet port at one end thereof, and a filtration membrane configured to fluidly communicate with the upper header and the lower header, the upper horizontal frame may include an upper cross pipe configured to allow one end of the upper header to be coupled thereto via the first outlet port, an upper cross bar configured to allow the other end of the upper header to be coupled thereto, a first upper horizontal member configured to connect one end of the upper cross pipe and one end of the upper cross bar to each other, and a second upper horizontal member configured to connect the other end of the upper cross pipe and the other end of the upper cross bar to each other, and the lower horizontal frame may include a lower cross pipe configured to allow one end of the lower header to be coupled thereto via the second outlet port, a lower cross bar configured to allow the other end of the lower header to be coupled thereto, a first lower horizontal member configured to connect one end of the lower cross pipe and one end of the lower cross bar to each other, and a second lower horizontal member configured to connect the other end of the lower cross pipe and the other end of the lower cross bar to each other.

The supporting frame may include a pair of parallel bars respectively having the first rail mounted thereon and at least one connecting bar configured to connect the pair of parallel bars to each other, and the vertical members may be coupled to the connecting bar.

The first rail may be elastically mounted on the bottom surface of the supporting frame such that the distance between the first rail and the supporting frame is variable.

The supporting frame may have a through-hole extending from a top surface thereof, which is opposite the bottom surface, to the bottom surface, the first rail may be mounted on the bottom surface of the supporting frame by means of a coupling member, the coupling member may include a head over the top surface of the supporting frame, a screw end inserted into the first rail, and a central body between the head and the screw end, the central body being movable along the through-hole and having a length longer than the through-hole, and an elastic member may be interposed between the supporting frame and the first rail.

The central body may include an exposed portion between the bottom surface of the supporting frame and the first rail, and the elastic member may be a spring surrounding the exposed portion.

The filtration system may further include a guide frame provided on the filtration tank, the guide frame may have a top surface that faces the free-roller, and the second rail may be mounted on the top surface of the guide frame.

The filtration system may further include a pivot member having a central hole, a first end of the pivot member may be pivotably coupled to the guide frame, a second end of the pivot member may be a two-pronged end having first and second fingers, a rotating shaft connected to a rotation axis of the free-roller may extend through the central hole of the pivot member, and a protrusion provided at the supporting frame may be disposed in a gap between the first and second fingers.

The protrusion may be a circular ring member coupled to the supporting frame by means of a screw.

The filtration system may further include a separation-preventing member coupled to an end of the rotating shaft such that the central hole is between the free-roller and the separation-preventing member.

The supporting frames of the plurality of filtration apparatuses may be separably coupled to each other, and each of the filtration apparatuses may further include a lifting hook receiver provided on the supporting frame.

The general description of the present disclosure given above is provided merely to illustrate or describe the present disclosure, and does not limit the scope of rights of the present disclosure.

### BRIEF DESCRIPTION OF THE DRAWINGS

The accompanying drawings, which are included to assist in understanding of the present disclosure and are incorporated in and constitute a part of the present specification, illustrate embodiments of the present disclosure and serve to explain the principle of the present disclosure together with the detailed description of the present disclosure.

FIG. 1 is an exploded perspective view schematically showing a filtration system according to a first embodiment of the present disclosure;

FIG. 2 is an exploded perspective view schematically showing a filtration apparatus of the filtration system;

FIGS. 3(a) and 3(b) are a perspective view and a sectional view, respectively, schematically showing a guide mechanism of the filtration system;

FIG. 4 is an exploded perspective view schematically showing a double-deck type filtration apparatus according to another embodiment of the present disclosure;

FIGS. 5(a) and 5(b) are sectional views schematically showing a guide mechanism according to another embodiment of the present disclosure;

FIGS. 6(a), 6(b), and 6(c) are a perspective view, a sectional view, and a front view, respectively, schematically showing a guide mechanism according to a further another embodiment of the present disclosure;

FIG. 7 is an exploded perspective view schematically showing a filtration system according to a second embodiment of the present disclosure;

FIG. 8 is an exploded perspective view schematically showing a filtration apparatus of the filtration system;

FIGS. 9(a) and 9(b) are a perspective view and a sectional view, respectively, schematically showing a guide mechanism of the filtration system;

FIGS. 10(a) and 10(b) are sectional views schematically showing a guide mechanism according to another embodiment of the present disclosure; and

FIGS. 11(a), 11(b), and 11(c) are a perspective view, a sectional view, and a front view, respectively, schematically showing a guide mechanism according to a further another embodiment of the present disclosure.

### DETAILED DESCRIPTION OF THE DISCLOSURE

Hereinafter, various embodiments of the present disclosure will be described in detail with reference to the accompanying drawings.

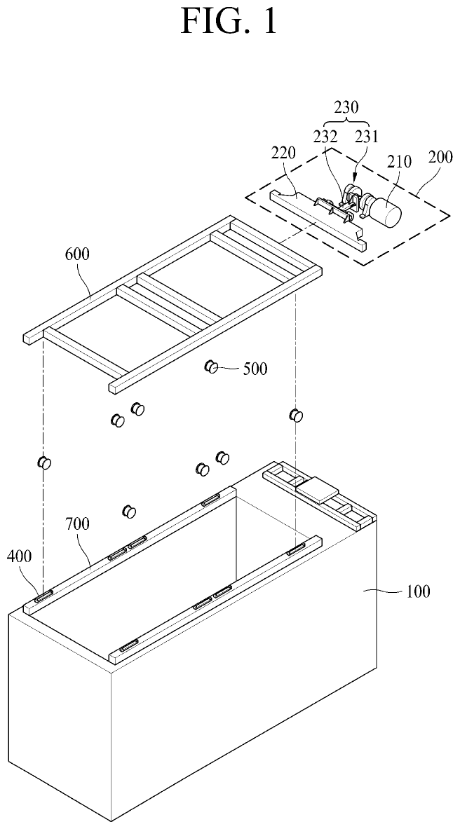

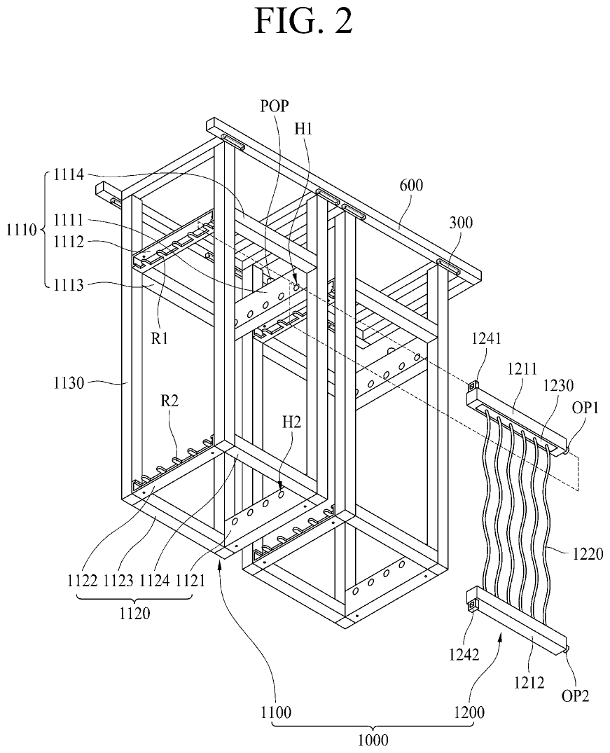

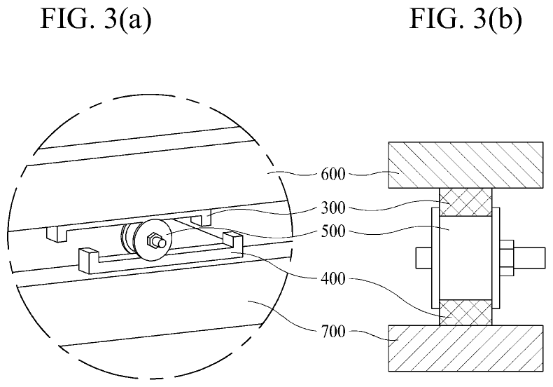

FIG. 1 is an exploded perspective view schematically showing a filtration system according to a first embodiment of the present disclosure, FIG. 2 is an exploded perspective view schematically showing a filtration apparatus of the filtration system, and FIGS. 3(a) and 3(b) are a perspective view and a sectional view, respectively, schematically showing a guide mechanism of the filtration system.

For simplicity of the drawings and easy understanding of the present disclosure, the filtration apparatus is omitted from FIG. 1.

As illustrated in FIGS. 1 to 3(b), the filtration system according to the first embodiment of the present disclosure includes a filtration tank 100 into which feed water to be treated is introduced, at least one filtration apparatus 1000 configured to perform filtration in the state in which at least a part of thereof is submerged in the feed water, a driving unit 200 for reciprocating motion of the filtration apparatus 1000, a first rail 300 configured to reciprocate together with the filtration apparatus 1000, a second rail 400 configured to guide the reciprocating motion of the filtration apparatus 1000, and a free-roller 500 located between the first and second rails 300 and 400.

Unlike Prior Art 1, in which the plurality of rollers is fixedly coupled to the reciprocating frame, the free-roller 500 of the present disclosure is not fixedly coupled to any frame and is therefore movable relative to both the first and second rails 300 and 400. During filtration, loads of the filtration apparatuses 1000 may be uniformly distributed to the free-rollers 500 of the present disclosure. As a result, the filtration system according to the present disclosure is capable of (i) cleaning a filtration membrane just with an amount of energy less than required in an aeration cleaning method, (ii) preventing damage to parts (particularly, damage to the roller) which otherwise might be caused due to the biased load, thereby dramatically reducing operation and maintenance costs, and (iii) inhibiting noise generation during the filtration.

The filtration system according to the first embodiment of the present disclosure further includes a reciprocating frame 600 to which the plurality of filtration apparatuses 1000 are individually coupled. The driving unit 200 is configured to implement the reciprocating motion of the filtration apparatuses 1000 through the reciprocating frame 600.

As illustrated in FIG. 1, the driving unit 200 may include a motor 210, a power transmission member 220 connected to the reciprocating frame 600, and a motion conversion mechanism 230 configured to convert rotational motion of the motor 210 into linear reciprocating motion of the power transmission member 220.

The motion conversion mechanism 230 may be a crank-rod mechanism. That is, the motion conversion mechanism 230 may include a crankshaft 231 rotatable by the motor 210 and a connecting rod 232 having one end connected to the crankshaft 231 and the other end connected to the power transmission member 220. Alternatively, the motion conversion mechanism 230 may be a cam-follower mechanism.

As illustrated in FIG. 2, each of the plurality of filtration apparatuses 1000 coupled to the reciprocating frame 600 may include a skid frame 1100 and a plurality of membrane modules 1200 installed therein.

The skid frame 1100 may include an upper horizontal frame 1110, a lower horizontal frame 1120, and a plurality of vertical members 1130 connecting the upper horizontal frame 1110 and the lower horizontal frame 1120 to each other. The skid frame 1100 may be coupled to the reciprocating frame 600 using a variety of known methods.

For example, as illustrated in FIG. 2, the vertical members 1130 may extend past the upper horizontal frame 1110, and these extensions may be coupled to the reciprocating frame 600. As a result, even when the driving unit 200, the reciprocating frame 600, the first and second rails 300 and 400, and the free-roller 500 are not submerged in the feed water in the filtration tank 100, the membrane modules 1200 of the filtration apparatus 1000 can be submerged in the feed water to perform filtration. Consequently, it is possible to minimize the number of parts that should be submerged in the feed water and are thus vulnerable to corrosion and to minimize the need to separately perform a corrosion-inhibiting chemical treatment.

Although not shown, in order to increase mechanical durability, the skid frame 1100 may further include a plurality of reinforcing rods configured to connect the vertical members 1130 and the upper and lower horizontal frames 1110 and 1120 to each other in various ways.

Each of the membrane modules 1200 may include an upper header 1211 having a first outlet port OP1 at one end thereof, a lower header 1212 having a second outlet port OP2 at one end thereof, and a filtration membrane 1220 configured to fluidly communicate with the upper header 1211 and the lower header 1212.

One end and the other end of the filtration membrane 1220 are fixed to the upper header 1211 and the lower header 1212 via potting layers 1230, respectively. The filtration membrane 1220 fluidly communicates with the upper header 1211 and the lower header 1212, whereby the permeate passing through the filtration membrane 1220 is introduced into the water-collecting spaces of the upper header 1211 and the lower header 1212. Subsequently, the permeate is discharged from the membrane module 1200 through the first outlet port OP1 of the upper header 1211 and the second outlet port OP2 of the lower header 1212.

Although a hollow fiber membrane having a longitudinal direction parallel to the vertical members 1130 is illustrated as the filtration membrane 1220 in FIG. 2, the filtration membrane 1220 of the present disclosure is not limited thereto, and may be a flat sheet membrane.

The upper header 1211 and the lower header 1212 are coupled to the upper horizontal frame 1110 and the lower horizontal frame 1120, respectively, whereby the membrane module 1200 is installed in the skid frame 1100.

Specifically, the upper horizontal frame 1110 may include an upper cross pipe 1111 to which one end of the upper header 1211 is coupled via the first outlet port OP1, an upper cross bar 1112 to which the other end of the upper header 1211 is coupled, a first upper horizontal member 1113 configured to connect one end of the upper cross pipe 1111 and one end of the upper cross bar 1112 to each other, and a second upper horizontal member 1114 configured to connect the other end of the upper cross pipe 1111 and the other end of the upper cross bar 1112 to each other. The first outlet port OP1 of the upper header 1211 is inserted into a first hole H1 of the upper cross pipe 1111, whereby the one end of the upper header 1211 is coupled to the upper cross pipe 1111. The permeate discharged from the upper header 1211 through the first outlet port OP1 is introduced into the upper cross pipe 1111 and then flows out through a permeate outlet port POP.

Similarly, the lower horizontal frame 1120 may include a lower cross pipe 1121 to which one end of the lower header 1212 is coupled via the second outlet port OP2, a lower cross bar 1122 to which the other end of the lower header 1212 is coupled, a first lower horizontal member 1123 configured to connect one end of the lower cross pipe 1121 and one end of the lower cross bar 1122 to each other, and a second lower horizontal member 1124 configured to connect the other end of the lower cross pipe 1121 and the other end of the lower cross bar 1122 to each other. The second outlet port OP2 of the lower header 1212 is inserted into a second hole H2 of the lower cross pipe 1121, whereby the one end of the lower header 1212 is coupled to the lower cross pipe 1121. The permeate discharged from the lower header 1212 through the second outlet port OP2 is introduced into the lower cross pipe 1121.

At least one of the vertical members 1130, which connect the upper cross pipe 1111 and the lower cross pipe 1121 to each other, may have a pipe shape that fluidly communicates therewith, whereby the permeate introduced into the lower cross pipe 1121 may flow into the upper cross pipe 1111 and then be discharged to the outside through the permeate outlet port POP.

Alternatively, a separate permeate outlet port may be provided at the lower cross pipe 1121 such that the permeate introduced into the lower cross pipe 1121 is discharged to the outside therethrough.

The other end of the upper header 1211 is coupled to the upper cross bar 1112. For example, as illustrated in FIG. 2, a first rib R1 provided at the upper cross bar 1112 may be inserted into a first receiving member 1241 provided at the other end of the upper header 1211, whereby the other end of the upper header 1211 may be coupled to the upper cross bar 1112.

Similarly, a second rib R2 provided at the lower cross bar 1122 may be inserted into a second receiving member 1242 provided at the other end of the lower header 1212, whereby the other end of the lower header 1212 may be coupled to the lower cross bar 1122.

The reciprocating frame 600, to which each of the plurality of filtration apparatuses 1000 is coupled, has a bottom surface that faces the free-roller 500, and the first rail 300 is mounted on the bottom surface of the reciprocating frame 600. When the reciprocating frame 600 is reciprocated by the driving unit 200, therefore, the first rail 300 of the present disclosure may reciprocate together with the filtration apparatuses 1000.

The filtration system may further include a guide frame 700 provided on the filtration tank 100. The guide frame 700 has a top surface that faces the free-roller 500, and the second rail 400 may be mounted on the top surface of the guide frame 700.

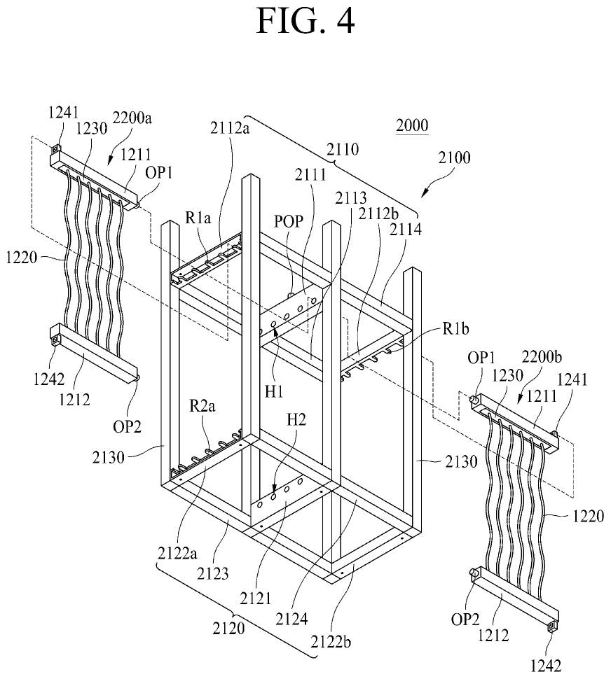

FIG. 4 is an exploded perspective view schematically showing a double-deck type filtration apparatus 2000 according to another embodiment of the present disclosure.

As illustrated in FIG. 4, a double-deck type filtration apparatus 2000 includes a skid frame 2100 having first and second interior spaces, first membrane modules 2200a installed in the first interior space, and second membrane modules 2200b installed in the second interior space.

The skid frame 2100 may include an upper horizontal frame 2110, a lower horizontal frame 2120, and a plurality of vertical members 2130 configured to connect the upper horizontal frame 2110 and the lower horizontal frame 2120 to each other. The vertical members 2130 may extend past the upper horizontal frame 2110, and these extensions may be coupled to the reciprocating frame 600.

Although not shown, in order to increase mechanical durability, the skid frame 2100 may further include a plurality of reinforcing rods configured to connect the vertical members 2130 and the upper and lower horizontal frames 2110 and 2120 to each other in various ways.

Each of the first and second membrane modules 2200a and 2200b may include an upper header 1211 having a first outlet port OP1 at one end thereof, a lower header 1212 having a second outlet port OP2 at one end thereof, and a filtration membrane 1220 configured to fluidly communicate with the upper header 1211 and the lower header 1212.

One end and the other end of the filtration membrane 1220 are fixed respectively to the upper header 1211 and the lower header 1212 via potting layers 1230. The filtration membrane 1220 fluidly communicates with the upper and lower headers 1211 and 1212, whereby the permeate passing through the filtration membrane 1220 is introduced into the water-collecting spaces of the upper header 1211 and the lower header 1212. Subsequently, the permeate is discharged from each of the membrane modules 2200a and 2200b through the first outlet port OP1 of the upper header 1211 and the second outlet port OP2 of the lower header 1212.

Although a hollow fiber membrane having a longitudinal direction parallel to the vertical members 2130 is illustrated as the filtration membrane 1220 in FIG. 4, the filtration membrane 1220 of the present disclosure is not limited thereto, and may be a flat sheet membrane.

The upper header 1211 and the lower header 1212 are coupled to the upper horizontal frame 2110 and the lower horizontal frame 2120, respectively, whereby each of the first and second membrane modules 2200a and 2200b is installed in the skid frame 2100.

Specifically, the upper horizontal frame 2110 may include a common upper cross pipe 2111, first and second upper cross bars 2112a and 2112b, a first upper horizontal member 2113 configured to connect one end of the common upper cross pipe 2111 and one end of each of the first and second upper cross bars 2112a and 2112b to each other, and a second upper horizontal member 2114 configured to connect the other end of the common upper cross pipe 2111 and the other end of each of the first and second upper cross bars 2112a and 2112b to each other. The common upper cross pipe 2111 has a longitudinal direction parallel to the first and second upper cross bars 2112a and 2112b, and is disposed between the first and second upper cross bars 2112a and 2112b.

The common upper cross pipe 2111 has first holes H1 formed in each of the surface thereof that faces the first upper cross bar 2112a and the opposite surface thereof (i.e. the surface thereof that faces the second upper cross bar 2112b). The first outlet ports OP1 of the first and second membrane modules 2200a and 2200b are inserted into the first holes H1, respectively, whereby one end of each of the upper headers 1211 of the first and second membrane modules 2200a and 2200b is coupled to the common upper cross pipe 2111. The permeate discharged through the first outlet port OP1 of each of the first and second membrane modules 2200a and 2200b is introduced into the common upper cross pipe 2111 and then flows out through a permeate outlet port POP.

Similarly, the lower horizontal frame 2120 may include a common lower cross pipe 2121, first and second lower cross bars 2122a and 2122b, a first lower horizontal member 2123 configured to connect one end of the common lower cross pipe 2121 and one end of each of the first and second lower cross bars 2122a and 2122b to each other, and a second lower horizontal member 2124 configured to connect the other end of the common lower cross pipe 2121 and the other end of each of the first and second lower cross bars 2122a and 2122b to each other. The common lower cross pipe 2111 has a longitudinal direction parallel to the first and second lower cross bars 2122a and 2122b, and is disposed between the first and second lower cross bars 2122a and 2122b.

The common lower cross pipe 2121 has second holes H2 formed in each of the surface thereof that faces the first lower cross bar 2122a and the opposite surface thereof (i.e. the surface thereof that faces the second lower cross bar 2122b). The second outlet ports OP2 of the first and second membrane modules 2200a and 2200b are inserted into the second holes H2, respectively, whereby one end of each of the lower headers 1212 of the first and second membrane modules 2200a and 2200b is coupled to the common lower cross pipe 2121. The permeate discharged through the second outlet port OP2 of each of the first and second membrane modules 2200a and 2200b is introduced into the common lower cross pipe 2121.

At least one of the vertical members 2130, which connect the common upper cross pipe 2111 and the common lower cross pipe 2121 to each other, may have a pipe shape that fluidly communicates therewith, whereby the permeate introduced into the common lower cross pipe 2121 may flow into the common upper cross pipe 2111 and then be discharged to the outside through the permeate outlet port POP.

Alternatively, a separate permeate outlet port may be provided at the common lower cross pipe 2121 such that the permeate introduced into the common lower cross pipe 2121 is discharged to the outside therethrough.

The other ends of the upper headers 1211 of the first and second membrane modules 2200a and 2200b are coupled to the first and second upper cross bars 2112a and 2112b, respectively. For example, as illustrated in FIG. 4, the first ribs R1 provided at the first and second upper cross bars 2112a and 2112b are inserted into the first receiving members 1241 provided at the other ends of the upper headers 1211 of the first and second membrane modules 2200a and 2200b, whereby the other ends of the upper headers 1211 of the first and second membrane modules 2200a and 2200b may be coupled to the first and second upper cross bars 2112a and 2112b, respectively.

Similarly, the second ribs R2 provided at the first and second lower cross bars 2122a and 2122b are inserted into the second receiving members 1242 provided at the other ends of the lower headers 1212 of the first and second membrane modules 2200a and 2200b, whereby the other ends of the lower headers 1212 of the first and second membrane modules 2200a and 2200b may be coupled to the first and second lower cross bars 2122a and 2122b, respectively.

In the double-deck type filtration apparatus 2000 described above, the degree of integration of the membrane modules 2200a and 2200b in the skid frame 2100 may be increased, whereby it is possible to improve the recovery rate of the filtration system.

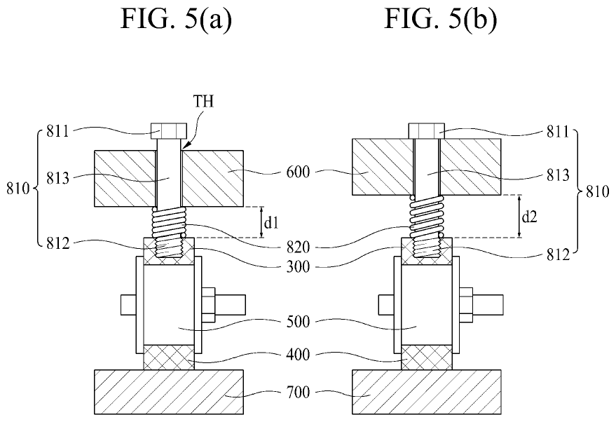

FIGS. 5(a) and 5(b) are sectional views schematically showing a guide mechanism according to another embodiment of the present disclosure.

According to the other embodiment of the present disclosure, the first rail 300 may be elastically mounted on the bottom surface of the reciprocating frame 600 such that the distance between the first rail 300 and the reciprocating frame 600 is variable (i.e. d1<->d2).

Specifically, as illustrated in FIGS. 5(a) and 5(b), the reciprocating frame 600 may have a through-hole TH extending from a top surface thereof, which is opposite the bottom surface, to the bottom surface, and the first rail 300 may be mounted on the bottom surface of the reciprocating frame 600 by means of a coupling member 810. The coupling member 810 may include a head 811 located over the top surface of the reciprocating frame 600, a screw end 812 inserted into the first rail 300, and a central body 813 between the head 811 and the screw end 812.

The central body 813 is movable along the through-hole TH, and has a length longer than the through-hole TH. An elastic member 820 is interposed between the reciprocating frame 600 and the first rail 300. For example, the central body 813 may include an exposed portion between the bottom surface of the reciprocating frame 600 and the first rail 300, and the elastic member 820 may be a spring surrounding the exposed portion.

The free-roller 500 of the present disclosure, which is not fixedly coupled to any frame, may always keep in contact with the second rail 400 on the guide frame 700 by virtue of gravity. On the other hand, due to the flatness difference between the reciprocating frame 600 and the guide frame 700, the contact between the first rail 300 mounted on the bottom surface of the reciprocating frame 600 and the free-roller 500 cannot always be maintained. According to the guide mechanism of the aforementioned embodiment of the present disclosure, however, even if the gap between a certain portion of the reciprocating frame 600 and the guide frame 700 temporarily increases during the reciprocating motion due to the flatness difference between the reciprocating frame 600 and the guide frame 700, the first rail 300 corresponding to the portion can move toward the corresponding free-roller 500 thanks to the elastic force of the elastic member 820 such that the contact between the first rail 300 and the free-roller 500 can always be secured. Therefore, it is possible to prevent any damage of the free-rollers 500 that otherwise might be caused due to load bias to some of the free-rollers 500. In addition, damage to the free-roller 500 and noise generation due to repeated contact and non-contact between the first rail 300 and the free-roller 500 may also be avoided.

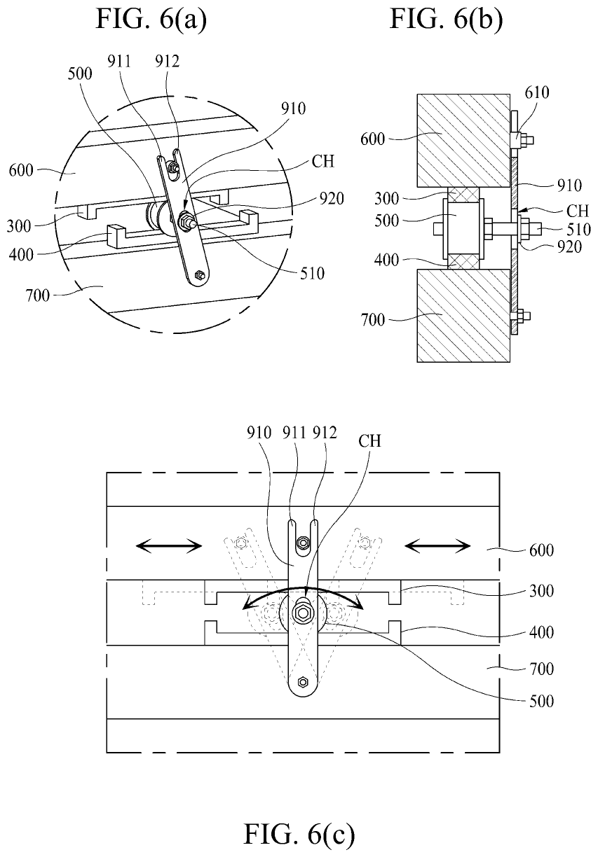

FIGS. 6(a), 6(b), and 6(c) are a perspective view, a sectional view, and a front view, respectively, schematically showing a guide mechanism according to a further another embodiment of the present disclosure.

As illustrated in FIGS. 6(a)-(c), the filtration system of the present disclosure may further include a pivot member 910 having a central hole CH. A first end of the pivot member 910 may be pivotably coupled to the guide frame 700, and a second end of the pivot member 910 may be a two-pronged end having first and second fingers 911 and 912.

A rotating shaft 510 connected to the rotation axis of the free-roller 500 may extend through the central hole CH of the pivot member 910, and a protrusion 610 provided at the reciprocating frame 600 may be disposed in the gap between the first and second fingers 911 and 912. The protrusion 610 may be a circular ring member coupled to the reciprocating frame 600 by means of a screw.

The reciprocating motion of the reciprocating frame 600 performed by the driving unit 200 causes (i) rotational and reciprocating motion of the free-roller 500, (ii) pivoting motion of the pivot member 910, and (iii) reciprocating motion of the protrusion 610 relative to the pivot member 910 in the gap between the first and second fingers 911 and 912 (i.e., reciprocating motion along a longitudinal direction of the gap).

The aforementioned pivot member 910 can prevent the free-roller 500 of the present disclosure from being separated from the filtration system. Optionally, the filtration system may further include a separation-preventing member 920 coupled to an end of the rotating shaft 510 such that the central hole CH of the pivot member 910 is between the free-roller 500 and the separation-preventing member 920.

The filtration system according to the present disclosure may employ only one of the guide mechanisms of FIGS. 5(a)-(b) and FIGS. 6(a)-(c), or may employ a combination thereof.

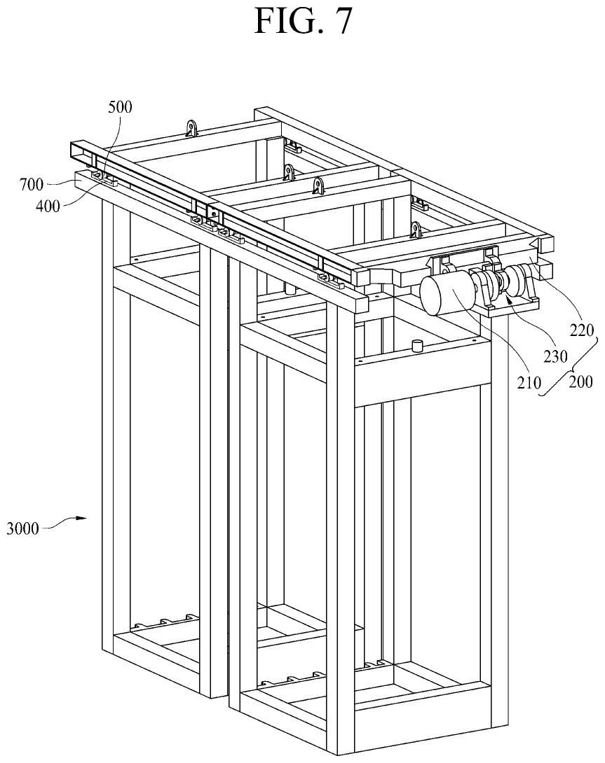

Hereinafter, a filtration system according to a second embodiment of the present disclosure will be described in detail with reference to FIGS. 7 to 9(b).

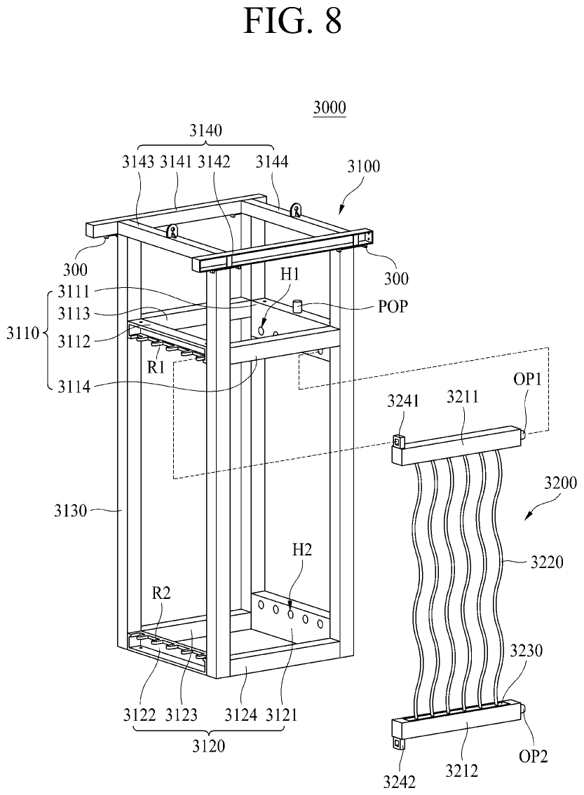

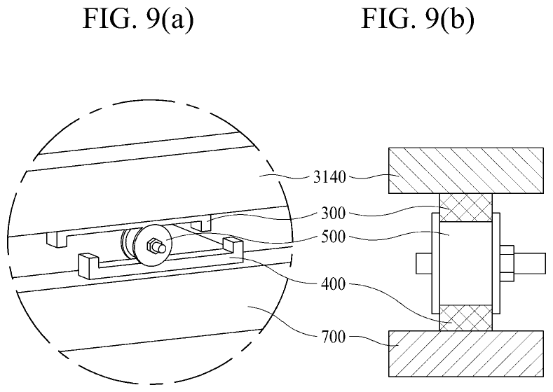

FIG. 7 is an exploded perspective view schematically showing a filtration system according to a second embodiment of the present disclosure, FIG. 8 is an exploded perspective view schematically showing a filtration apparatus of the filtration system, and FIGS. 9(a) and 9(b) are a perspective view and a sectional view, respectively, schematically showing a guide mechanism of the filtration system.

It should be noted that, for simplicity of the drawings and easy understanding of the present disclosure, a filtration tank and a membrane module of the filtration apparatus are omitted from FIG. 7.

As illustrated in FIGS. 7 to 9(b), the filtration system according to the second embodiment of the present disclosure includes a plurality of filtration apparatuses 3000 configured to perform filtration in the state in which at least a part thereof is submerged in feed water introduced into a filtration tank (not shown), a driving unit 200 for reciprocating motion of the filtration apparatuses 3000, first rails 300 configured to reciprocate together with the filtration apparatuses 3000, second rails 400 configured to guide the reciprocating motion of the filtration apparatuses 3000, and free-rollers 500 located between the first and second rails 300 and 400.

Just like the filtration system according to the first embodiment of the present disclosure, the free-roller 500 is not fixedly coupled to any frame and is therefore movable relative to both the first and second rails 300 and 400. In addition, loads of the filtration apparatuses 3000 may be uniformly distributed to the free-rollers 500 of the present disclosure during the filtration. As a result, the filtration system according to the second embodiment of the present disclosure is also capable of (i) cleaning a filtration membrane just with an amount of energy less than required in an aeration cleaning method, (ii) preventing damage to parts (particularly, damage to the roller) which otherwise might be caused due to the biased load, thereby dramatically reducing operation and maintenance costs, and (iii) inhibiting noise generation during the filtration.

As illustrated in FIG. 8, each of the filtration apparatuses 3000 may include a skid frame 3100 and a plurality of membrane modules 3200 installed therein.

The skid frame 3100 may include a supporting frame 3140, a lower horizontal frame 3120, an upper horizontal frame 3110 located between the supporting frame 3140 and the lower horizontal frame 3120, and a plurality of vertical members 3130 configured to connect the supporting frame 3140, the upper horizontal frame 3110, and the lower horizontal frame 3120 to each other.

Although not shown, in order to increase mechanical durability, the skid frame 3100 may further include a plurality of reinforcing rods configured to connect the supporting frame 3140, the upper and lower horizontal frames 3110 and 3120, and the vertical members 3130 to each other in various ways.

The supporting frame 3140 may have a bottom surface that faces the free-roller 500, and the first rail 300 may be mounted on the bottom surface of the supporting frame 3140. Therefore, when the filtration apparatus 3000 is reciprocated by the driving unit 200, the first rail 300 of the present disclosure can reciprocate together with the filtration apparatuses 3000.

Each of the membrane modules 3200 may include an upper header 3211 having a first outlet port OP1 at one end thereof, a lower header 3212 having a second outlet port OP2 at one end thereof, and a filtration membrane 3220 configured to fluidly communicate with the upper header 3211 and the lower header 3212.

One end and the other end of the filtration membrane 3220 are fixed to the upper and lower headers 3211 and 3212, respectively, via potting layers 3230. The filtration membrane 3220 fluidly communicates with the upper and lower headers 3211 and 3212, whereby the permeate passing through the filtration membrane 3220 is introduced into the water-collecting spaces of the upper and lower headers 3211 and 3212. Subsequently, the permeate is discharged from the membrane module 3200 through the outlet ports OP1 and OP2 of the upper and lower headers 3211 and 3212.

The upper and lower headers 3211 and 3212 are coupled to the upper and lower horizontal frames 3110 and 3120, respectively, whereby the membrane module 3200 is installed in the skid frame 3100.

Specifically, the upper horizontal frame 3110 may include an upper cross pipe 3111 to which one end of the upper header 3211 is coupled via the first outlet port OP1, an upper cross bar 3112 to which the other end of the upper header 3211 is coupled, a first upper horizontal member 3113 configured to connect one end of the upper cross pipe 3111 and one end of the upper cross bar 3112 to each other, and a second upper horizontal member 3114 configured to connect the other end of the upper cross pipe 3111 and the other end of the upper cross bar 3112 to each other. The first outlet port OP1 of the upper header 3211 is inserted into a first hole H1 of the upper cross pipe 3111, whereby the one end of the upper header 3211 is coupled to the upper cross pipe 3111. The permeate discharged from the upper header 3211 through the first outlet port OP1 is introduced into the upper cross pipe 3111 and then flows out through a permeate outlet port POP.

Similarly, the lower horizontal frame 3120 may include a lower cross pipe 3121 to which one end of the lower header 3212 is coupled via the second outlet port OP2, a lower cross bar 3122 to which the other end of the lower header 3212 is coupled, a first lower horizontal member 3123 configured to connect one end of the lower cross pipe 3121 and one end of the lower cross bar 3122 to each other, and a second lower horizontal member 3124 configured to connect the other end of the lower cross pipe 3121 and the other end of the lower cross bar 3122 to each other. The second outlet port OP2 of the lower header 3212 is inserted into a second hole H2 of the lower cross pipe 3121, whereby the one end of the lower header 3212 is coupled to the lower cross pipe 3121. The permeate discharged from the lower header 3212 through the second outlet port OP2 is introduced into the lower cross pipe 3121.

At least one of the vertical members 3130, which connect the upper cross pipe 3111 and the lower cross pipe 3121 to each other, may have a pipe shape that fluidly communicates therewith, such that the permeate introduced into the lower cross pipe 3121 can flow into the upper cross pipe 3111 and then be discharged to the outside through the permeate outlet port POP.

Alternatively, a separate permeate outlet port may be provided at the lower cross pipe 3121 such that the permeate introduced into the lower cross pipe 3121 is discharged to the outside therethrough.

The other end of the upper header 3211 is coupled to the upper cross bar 3112. For example, as illustrated in FIG. 8, a first rib R1 provided at the upper cross bar 3112 may be inserted into a first receiving member 3241 provided at the other end of the upper header 3211, whereby the other end of the upper header 3211 may be coupled to the upper cross bar 3112.

Similarly, a second rib R2 provided at the lower cross bar 3122 may be inserted into a second receiving member 3242 provided at the other end of the lower header 3212, whereby the other end of the lower header 3212 may be coupled to the lower cross bar 3122.

In the filtration system according to the second embodiment of the present disclosure, the supporting frame 3140 is disposed above the upper and lower horizontal frames 3110 and 3120 to which the membrane modules 3200 are coupled, and the first rail 300 is mounted on the supporting frame 3140. Therefore, even when the driving unit 200, the supporting frame 3140, the first and second rails 300 and 400, the free-roller 500, etc. are not submerged in feed water, the membrane modules 3200 of the filtration apparatus 3000 can be submerged in the feed water to perform filtration. Consequently, it is possible to minimize the number of parts that should be submerged in the feed water and are thus vulnerable to corrosion and minimize the need to separately perform a corrosion-inhibiting chemical treatment.

Instead of the filtration apparatus 3000 illustrated in FIG. 8, a filtration apparatus provided by coupling the supporting frame 3140 to the double-deck type filtration apparatus 2000 illustrated in FIG. 4 may be used. Even in this case, the first rail 300 is mounted on the bottom surface of the supporting frame 3140.

As illustrated in FIG. 8, the supporting frame 3140 of the skid frame 3100 may include a pair of parallel bars 3141 and 3142 on each of which the first rail 300 is mounted and at least one connecting bar 3143 and/or 3144 configured to connect the pair of parallel bars 3141 and 3142 to each other, and the vertical members 3130 may be coupled to the connecting bar 3143 and/or 3144.

As illustrated in FIG. 7, the filtration system may further include a guide frame 700 provided on the filtration tank (not shown), the guide frame 700 may have a top surface that faces the free-roller 500, and the second rail 400 may be mounted on the top surface of the guide frame.

As illustrated in FIG. 7, the driving unit 200 may include a motor 210, a power transmission member 220 connected to the filtration apparatus 3000, and a motion conversion mechanism 230 configured to convert rotational motion of the motor 210 into linear reciprocating motion of the power transmission member 220.

The motion conversion mechanism 230 may be a crank-rod mechanism. That is, the motion conversion mechanism 230 may include a crankshaft rotatable by the motor 210 and a connecting rod having one end connected to the crankshaft and the other end connected to the power transmission member 220. Alternatively, the motion conversion mechanism 230 may be a cam-follower mechanism.

As illustrated in FIG. 7, the filtration system according to the second embodiment of the present disclosure includes a plurality of filtration apparatuses 3000 arranged side by side in the direction of the linear reciprocating motion. For example, the power transmission member 220 of the driving unit 200 is directly coupled to the supporting frame of the first filtration apparatus, and the supporting frame of the first filtration apparatus is directly coupled to the supporting frame of the second filtration apparatus. Consequently, the driving unit 200 becomes a direct driving source for reciprocating movement of the first filtration apparatus, and the first filtration apparatus becomes a direct driving source for reciprocating movement of the second filtration apparatus. That is, the driving unit 200 acts as an indirect driving source for the filtration apparatus(es) other than the filtration apparatus directly coupled thereto.

The supporting frame 3140 of each filtration apparatus 3000 may be detachably coupled to the power transmission member 220 and/or the support frame(s) of other filtration apparatus(es) by means of, for example, bolts. If any one of the plurality of filtration apparatuses 3000 is damaged, therefore, it is possible to remove only the damaged filtration apparatus from the filtration tank for repair or replacement. As a result, maintenance of the filtration system may be easily performed at a relatively low cost. In order to easily remove only the damaged filtration apparatus from the filtration tank, each of the filtration apparatuses 3000 may further include a lifting hook receiver 3150 provided on the supporting frame 3140.

The filtration system according to the second embodiment of the present disclosure is different from Prior Art 1 and the filtration system according to the first embodiment described above in that no “reciprocating frame” is used. Since the reciprocating frame needs to be large enough to allow a plurality of filtration apparatuses to be simultaneously connected thereto, (i) there is inconvenience in that the transportation constraints such as traffic regulations require the respective parts of the reciprocating frame to be transported individually to a water treatment site and then assembled into a complete reciprocating frame by welding, and (ii) there are difficulty and inconvenience in that, even when a part of only one filtration apparatus (e.g. a membrane module) is damaged, it is necessary to lift the heavy reciprocating frame and all the filtration apparatuses connected thereto as well, for the repair of the damaged part. On the other hand, in the filtration system according to the second embodiment of the present disclosure, which does not employ a reciprocating frame, (i) transportation of the reciprocating frame by parts and welding thereof at the water treatment site may be omitted, whereby it is possible to easily install the filtration system at a relatively low cost, and (ii) when a certain filtration apparatus is damaged during filtration, only the damaged filtration apparatus can be separated and removed from the filtration tank, whereby maintenance of the filtration system is relatively easy and it is possible to dramatically reduce the cost.

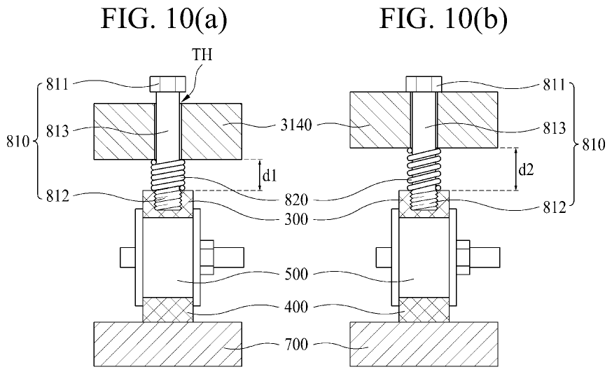

FIGS. 10(a) and 10(b) are sectional views schematically showing a guide mechanism according to another embodiment of the present disclosure.

According to the other embodiment of the present disclosure, the first rail 300 may be elastically mounted on the bottom surface of the supporting frame 3140 such that the distance between the first rail 300 and the supporting frame 3140 of the filtration apparatus 3000 is variable (i.e. d1<->d2).

Specifically, as illustrated in FIGS. 10(a)-(b), the supporting frame 3140 may have a through-hole TH extending from a top surface thereof, which is opposite the bottom surface, to the bottom surface, and the first rail 300 may be mounted on the bottom surface of the supporting frame 3140 by means of a coupling member 810. The coupling member 810 may include a head 811 located over the top surface of the supporting frame 3140, a screw end 812 inserted into the first rail 300, and a central body 813 between the head 811 and the screw end 812.

The central body 813 is movable along the through-hole TH, and has a length longer than the through-hole TH. An elastic member 820 is interposed between the supporting frame 3140 and the first rail 300. For example, the central body 813 may include an exposed portion between the bottom surface of the supporting frame 3140 and the first rail 300, and the elastic member 820 may be a spring surrounding the exposed portion.

The free-roller 500 of the present disclosure, which is not fixedly coupled to any frame, may always keep in contact with the second rail 400 on the guide frame 700 by virtue of gravity. On the other hand, due to the flatness difference between the supporting frame 3140 and the guide frame 700, the contact between the first rail 300 mounted on the bottom surface of the supporting frame 3140 and the free-roller 500 cannot always be maintained. According to the guide mechanism of the aforementioned embodiment of the present disclosure, however, even if the gap between a certain portion of the supporting frame 3140 and the guide frame 700 temporarily increases during the reciprocating motion due to the flatness difference between the supporting frame 3140 and the guide frame 700, the first rail 300 corresponding to the portion can move toward the corresponding free-roller 500 thanks to the elastic force of the elastic member 820, such that the contact between the first rail 300 and the free-roller 500 can always be secured. Therefore, it is possible to prevent any damage of the free-rollers 500 that otherwise might be caused due to load bias to some of the free-rollers 500. In addition, damage to the free-roller 500 and noise generation due to repeated contact and non-contact between the first rail 300 and the free-roller 500 may also be prevented.

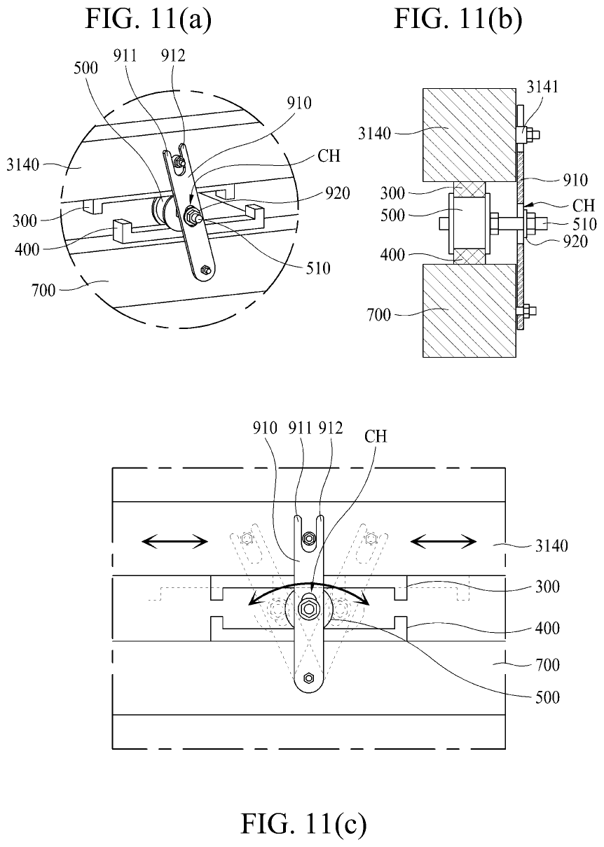

FIGS. 11(a), 11(b), and 11(c) are a perspective view, a sectional view, and a front view, respectively, schematically showing a guide mechanism according to a further embodiment of the present disclosure.

As illustrated in FIGS. 11(a)-11(c), the filtration system may further include a pivot member 910 having a central hole CH. A first end of the pivot member 910 may be pivotably coupled to the guide frame 700, and a second end of the pivot member 910 may be a two-pronged end having first and second fingers 911 and 912.

A rotating shaft 510 connected to the rotation axis of the free-roller 500 may extend through the central hole CH of the pivot member 910, and a protrusion 3141 provided at the supporting frame 3140 may be disposed in the gap between the first and second fingers 911 and 912. The protrusion 3141 may be a circular ring member coupled to the supporting frame 3140 by means of a screw.

Since a two-pronged end is employed as the second end of the pivot member 910 instead of an end having an elongated hole, it is possible to prevent the protrusion 3141 from acting as an obstacle when only the damaged filtration apparatus 3000 is separated and removed.

The reciprocating motion of the filtration apparatus 3000 performed by the driving unit 200 causes (i) rotational and reciprocating motion of the free-roller 500, (ii) pivoting motion of the pivot member 910, and (iii) reciprocating motion of the protrusion 3141 relative to the pivot member 910 in the gap between the first and second fingers 911 and 912 (i.e., reciprocating motion along a longitudinal direction of the gap).

The aforementioned pivot member 910 can prevent the free-roller 500 of the present disclosure from being separated from the filtration system. Optionally, the filtration system may further include a separation-preventing member 920 coupled to an end of the rotating shaft 510 such that the central hole CH of the pivot member 910 is between the free-roller 500 and the separation-preventing member 920.

The filtration system according to the second embodiment of the present disclosure may employ only one of the guide mechanisms of FIGS. 10(a)-(b) and FIGS. 11(a)-(c), or may employ a combination thereof.

Unlike Prior Art 1 in which the plurality of rollers fixedly coupled to the reciprocating frame cannot simultaneously contact the guide rail, whereby load is biased to only some rollers, the present disclosure adopts a novel concept of a “free-roller” that is not fixedly coupled to any frame, whereby load of filtration apparatus(es) may be uniformly distributed to all free-rollers during the filtration operation.

Consequently, the filtration system according to the present disclosure is capable of (i) cleaning a filtration membrane just with an amount of energy less than required in an aeration cleaning method, (ii) preventing damage to parts (particularly, the roller) which otherwise might be caused due to the biased load, thereby dramatically reducing operation and maintenance costs, and (iii) inhibiting noise generation during the filtration operation.

What is claimed is:

1. A filtration system comprising:
a filtration tank into which feed water to be treated is introduced;
at least one filtration apparatus configured to perform filtration in a state in which at least a part of the filtration apparatus is submerged in the feed water;
a driving unit for reciprocating motion of the filtration apparatus;
a first rail configured to reciprocate together with the filtration apparatus;
a second rail configured to guide the reciprocating motion of the filtration apparatus; and
a free-roller located between the first and second rails, the free-roller being movable relative to both the first and second rails.

2. The filtration system according to claim 1, wherein
the filtration system comprises a plurality of the filtration apparatuses,
the filtration system further comprises a reciprocating frame to which the filtration apparatuses are individually coupled,
the driving unit is configured to implement the reciprocating motion of the filtration apparatuses through the reciprocating frame,
the reciprocating frame has a bottom surface that faces the free-roller, and
the first rail is mounted on the bottom surface of the reciprocating frame.

3. The filtration system according to claim 2, wherein the first rail is elastically mounted on the bottom surface of the reciprocating frame such that a distance between the first rail and the reciprocating frame is variable.

4. The filtration system according to claim 3, wherein
the reciprocating frame has a through-hole extending from a top surface thereof, which is opposite the bottom surface, to the bottom surface,
the first rail is mounted on the bottom surface of the reciprocating frame by means of a coupling member,
the coupling member comprises:
a head located over the top surface of the reciprocating frame;
a screw end inserted into the first rail; and
a central body between the head and the screw end, the central body being movable along the through-hole and having a length longer than the through-hole, and
an elastic member is interposed between the reciprocating frame and the first rail.

5. The filtration system according to claim 4, wherein
the central body comprises an exposed portion between the bottom surface of the reciprocating frame and the first rail, and
the elastic member is a spring surrounding the exposed portion.

6. The filtration system according to claim 2, wherein
the filtration system further comprises a guide frame provided on the filtration tank,
the guide frame has a top surface that faces the free-roller, and
the second rail is mounted on the top surface of the guide frame.

7. The filtration system according to claim 6, wherein
the filtration system further comprises a pivot member having a central hole,
a first end of the pivot member is pivotably coupled to the guide frame,
a second end of the pivot member is a two-pronged end having first and second fingers,
a rotating shaft connected to a rotation axis of the free-roller extends through the central hole of the pivot member, and
a protrusion provided at the reciprocating frame is disposed in a gap between the first and second fingers.

8. The filtration system according to claim 7, wherein the protrusion is a circular ring member coupled to the reciprocating frame by means of a screw.

9. The filtration system according to claim 7, further comprising a separation-preventing member coupled to an end of the rotating shaft such that the central hole is between the free-roller and the separation-preventing member.

10. The filtration system according to claim 1, wherein
the filtration system comprises a plurality of the filtration apparatuses,
each of the filtration apparatuses comprises:
a skid frame; and
a plurality of membrane modules installed in the skid frame,
the skid frame comprises:
a supporting frame;
a lower horizontal frame;
an upper horizontal frame located between the supporting frame and the lower horizontal frame; and
a plurality of vertical members configured to connect the supporting frame, the upper horizontal frame, and the lower horizontal frame to each other,
the supporting frame has a bottom surface that faces the free-roller, and
the first rail is mounted on the bottom surface of the supporting frame.

11. The filtration system according to claim 10, wherein
each of the membrane modules comprises:
an upper header having a first outlet port at one end thereof;
a lower header having a second outlet port at one end thereof; and
a filtration membrane configured to fluidly communicate with the upper header and the lower header,
the upper horizontal frame comprises:
an upper cross pipe configured to allow one end of the upper header to be coupled thereto via the first outlet port;
an upper cross bar configured to allow the other end of the upper header to be coupled thereto;
a first upper horizontal member configured to connect one end of the upper cross pipe and one end of the upper cross bar to each other; and
a second upper horizontal member configured to connect the other end of the upper cross pipe and the other end of the upper cross bar to each other, and
the lower horizontal frame comprises:
a lower cross pipe configured to allow one end of the lower header to be coupled thereto via the second outlet port;
a lower cross bar configured to allow the other end of the lower header to be coupled thereto;
a first lower horizontal member configured to connect one end of the lower cross pipe and one end of the lower cross bar to each other; and
a second lower horizontal member configured to connect the other end of the lower cross pipe and the other end of the lower cross bar to each other.

12. The filtration system according to claim 10, wherein
the supporting frame comprises:
a pair of parallel bars respectively having the first rail mounted thereon; and
at least one connecting bar configured to connect the pair of parallel bars to each other, and
the vertical members are coupled to the connecting bar.

13. The filtration system according to claim 10, wherein the first rail is elastically mounted on the bottom surface of the supporting frame such that a distance between the first rail and the supporting frame is variable.

14. The filtration system according to claim 13, wherein
the supporting frame has a through-hole extending from a top surface thereof, which is opposite the bottom surface, to the bottom surface,
the first rail is mounted on the bottom surface of the supporting frame by means of a coupling member,
the coupling member comprises:
a head located over the top surface of the supporting frame;
a screw end inserted into the first rail; and
a central body between the head and the screw end, the central body being movable along the through-hole and having a length longer than the through-hole, and
an elastic member is interposed between the supporting frame and the first rail.

15. The filtration system according to claim 14, wherein
the central body comprises an exposed portion between the bottom surface of the supporting frame and the first rail, and
the elastic member is a spring surrounding the exposed portion.

16. The filtration system according to claim 10, wherein
the filtration system further comprises a guide frame provided on the filtration tank,
the guide frame has a top surface that faces the free-roller, and
the second rail is mounted on the top surface of the guide frame.

17. The filtration system according to claim 16, wherein
the filtration system further comprises a pivot member having a central hole,
a first end of the pivot member is pivotably coupled to the guide frame,
a second end of the pivot member is a two-pronged end having first and second fingers,
a rotating shaft connected to a rotation axis of the free-roller extends through the central hole of the pivot member, and
a protrusion provided at the supporting frame is disposed in a gap between the first and second fingers.

18. The filtration system according to claim 17, wherein the protrusion is a circular ring member coupled to the supporting frame by means of a screw.

19. The filtration system according to claim 17, further comprising a separation-preventing member coupled to an end of the rotating shaft such that the central hole is between the free-roller and the separation-preventing member.

20. The filtration system according to claim 10, wherein
the supporting frames of the plurality of filtration apparatuses are separably coupled to each other, and
each of the filtration apparatuses further comprises a lifting hook receiver provided on the supporting frame.
